(19) United States
(12) Patent Application Publication
(10) Pub. No.: US 2008/0244542 A1
(43) Pub. Date: Oct. 2, 2008

(54) SOAP SERVICE-ORIENTED SYSTEMS AND METHODS

(76) Inventor: Paul TOTH, Boise, ID (US)

Correspondence Address: Zarian Midgley & Johnson PLLC, University Plaza, 960 Broadway Ave., Suite 250, Boise, ID, 83706, US

(21) Appl. No.: 12/061,455

(22) Filed: Apr. 2, 2008

Related U.S. Application Data
(60) Provisional application No. 60/909,600, filed on Apr. 2, 2007.

(51) Int. Cl. G06F 9/45

(52) U.S. Cl. 717/143

(57) ABSTRACT

A service-oriented computer programming language is disclosed. The language includes keywords and operators that enable simple definition and invocation of SOAP services. In operation, a linkable data entity can be associated with one or more SOAP services dynamically, such that the SOAP services associated with the linkable data entity at any given time can change as a computer program executes. In addition, once a SOAP service is associated with a linkable data entity, the association can persist until it is eliminated, changed, or the computer program completes execution.

### CROSS-REFERENCE TO RELATED APPLICATIONS

This application claims the benefit under 35 U.S.C. §119(e) of U.S. Provisional Patent Application No. 60/909,600, filed Apr. 2, 2007, entitled FULLY INTEGRATED SERVICE-ORIENTED LANGUAGE, the disclosure of which is hereby incorporated herein by reference in its entirety.

### BACKGROUND

The present application relates to the field software development technology. More specifically, it relates to a programming language environment for developing, deploying, maintaining, and utilizing Service Oriented Architecture (“SOA”) compliant Web services.

Generally, SOA relates to developing, deploying, maintaining, and utilizing Web services. Numerous well-known protocols and standards such as XML, WSDL, SOAP, XPath, and XML-Schema are defined by the World Wide Web Consortium (W3C) and are commonly understood to be integral to adoption of SOA. The following standards promulgated by the W3C are hereby incorporated by reference in their entireties: XML Version 1.1 (Second Edition) (http://www.w3.org/TR/2006/REC-xml11-20060816/), XML Schema Version 1.1 (http://www.w3.org/XML/Schema), SOAP Version 1.2 (http ://www.w3.org/TR/2007/REC-soap12-part0-20070427/), XML Path Language (XPath) Version 1.0 (http://www.w3.org/TR/xpath). Currently, Web services are frequently accessed using programming languages that can be categorized as either procedural or object-oriented in nature.

Generally, communication between a program and an external service is accomplished by generating a structured document that conforms to a communications protocol and can be sent to the external service. These communications are often referred to as SOAP calls, referring to a popular protocol for exchanging information between machines. In order to generate a SOAP call, some of the code in a program is often translated from a procedural or object-oriented form into a SOAP compliant form.

SOAP compliant forms often take the form of a “structured document,” which refers generally to a class of documents having a predefined syntactical structure. Structured documents generally are composed exclusively of human readable text with common letters and whitespace characters and contain no executable statements. Structured documents are typically hierarchical and are generally composed of self-defined structures that can be discerned by visual examination of the text of the structured document. Well known structured document formats include SGML and its derivatives such as XML or HTML.

The translation of code from a procedural or object-oriented programming language into a SOAP compliant form is frequently accomplished through the use of tools such as external libraries, third party extensions, marshalling frameworks, and autogenerated code to bridge the gap. If a programmer does not have access to such tools, it can be very difficult to link to a Web service from a procedural or object-oriented programming language. Moreover, while these tools enable existing programming languages to access Web services, the tools are often cumbersome and inefficient. For example, a programmer may be required to create a SOAP call each time a Web service is used. Also, because the tools are frequently external to the programming language, the programmer may not have the ability to manipulate the format of the SOAP call, withholding significant control from the programmer.

### SUMMARY

In one embodiment, a method of processing an executable computer program with a language processor is provided. The method comprises parsing a keyword in the executable computer program, the keyword defining a SOAP service invocation and generating a first output recognizing the presence of the SOAP service invocation in the executable computer program. The method further comprises adding semantic information to the first output, and generating a second output based on the contents of the first output and including one or more structures containing the SOAP service invocation, including a reference to an operation associated with the SOAP service.

In another embodiment, another method of processing an executable computer program with a language processor is provided. The additional method comprises parsing a keyword in the executable computer program, the keyword defining a SOAP service, and generating a first output recognizing the presence of the SOAP service in the executable computer program, as well as one or more operations and message input and output types associated with the SOAP service. The method further comprises adding semantic information to the first output, and generating a second output based on the contents of the first output and including one or more structures containing the SOAP service, including one or more associated operations, message input and output type references, and statements defining behaviors of each operation.

In another embodiment, a method for linking one or more SOAP services to a linkable data entity in an executable computer program is provided. The method comprises identifying the linkable data entity and associating the linkable data entity with one or more SOAP services. The SOAP services associated with the linkable data entity at any given time can change as the computer program executes. In addition, once a SOAP service is associated with the linkable data entity, the association persists until it is eliminated, changed, or the computer program completes execution.

### BRIEF DESCRIPTION OF THE DRAWINGS

FIG. 1 is a flow chart illustrating a simple, high level example of a service linking method.

FIG. 2 is a flow chart illustrating an example of the persistent nature of a service link.

FIG. 3 is a block diagram of a service having an associated service context.

FIG. 4 is a flow chart illustrating a method of executing a service having an associated context.

FIG. 5 is a flow chart of a method demonstrating the execution of program implementing service linking.

FIGS. 6A-6E are block diagrams illustrating various “snapshots” of the relationship between a linkable data entity and a plurality of services at different moments in time during the execution of the program shown in FIG. 5.

FIG. 7 is a block diagram of one embodiment of a programming language processor, such as an interpreter.

### DETAILED DESCRIPTION

In the following description, reference is made to the accompanying drawings that form a part thereof, and in which is shown by way of illustration specific exemplary embodiments in which the invention may be practiced. These embodiments are described in sufficient detail to enable those skilled in the art to practice the invention, and it is to be understood that modifications to the various disclosed embodiments may be made, and other embodiments may be utilized, without departing from the spirit and scope of the present invention. The following detailed description is, therefore, not to be taken in a limiting sense.

As described above, the mechanisms for accessing Web services using existing procedural or object-oriented programming languages are often cumbersome and inefficient. The systems and methods described below overcome these deficiencies by employing a programming language that is service oriented in nature, rather than being procedural or object-oriented in nature. In some embodiments, the techniques by which standards pertaining to the functional basis for SOA can be fully integrated into the service-oriented programming language. This approach significantly enhances a programmer's access to Web services, preferably without the need for external libraries, third party extensions, marshalling frameworks, or autogenerated code.

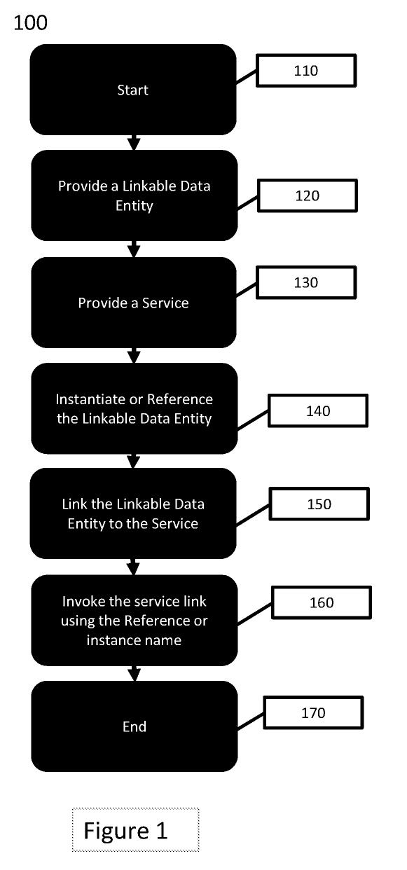

FIG. 1 is a flow chart illustrating one simple, high level example of a service linking method 100. In this example, at a first block 110, the method 100 begins. At block 120, a linkable data entity is created. As described in more detail below, the term “linkable data entity” as used in this disclosure, refers to a type that is a collection of constraints on named data values or a named executable construct that generates an instance of such a type. For example, in some embodiments, a linkable data entity comprises a type as defined by the XML Schema Standard promulgated by the W3C.

One example of a linkable data entity is a “type instance,” which is an entity that may be created and manipulated internally using a programming language, and which conforms to a specific data type. A type instance typically consists of either a variable referencing atomic instance of a predefined type, such as a floating point number representation, or a variable referencing an object which is an instance of a class defined using that language. Another example of a linkable data entity is an “executable element,” which consists of a named block of code that may be passed arguments and executed by a local client.

At block 130, a service is created. As used herein, the term “service” refers to a SOAP service, as understood by practitioners of SOA. The service created at block 130 may be a local (same host) service or a remote (external host) service. For example, in some embodiments, the service is a Web service compliant with the SOAP Version 1.2 standard. A Web service is a software system designed to support interoperable machine-to-machine interaction over a network. It has an interface described in a machine-processable format (specifically WSDL). Other systems interact with the Web service in a manner prescribed by its description using SOAP messages, typically conveyed using HTTP with an XML serialization in conjunction with other Web-related standards.

In some embodiments, the service-oriented programming language described herein provides one or more unique keywords or operators, such as “service,” that make it easy for a programmer to define a SOAP service. Such keywords and operators advantageously enable the service-oriented programming language to define services far more conveniently and efficiently than existing procedural and object-oriented programming languages. The creation of the linkable data entity and the service shown in blocks 120 and 130 may be performed by various parties and in any order. For example, in some cases, the service and the linkable data entity are created by third parties, well before a program referencing the linkable data entity and the service is executed.

At block 140, the linkable data entity may be instantiated or referenced, depending on the kind of linkable data entity that was created at block 120. For example, if the linkable data entity is a format definition such as a type, it would need to be instantiated before a service could be invoked. However, if the linkable data entity is an executable element, which is instantiated at the time of construction, the linkable data entity does not need to be instantiated again and may be referenced with a variable.

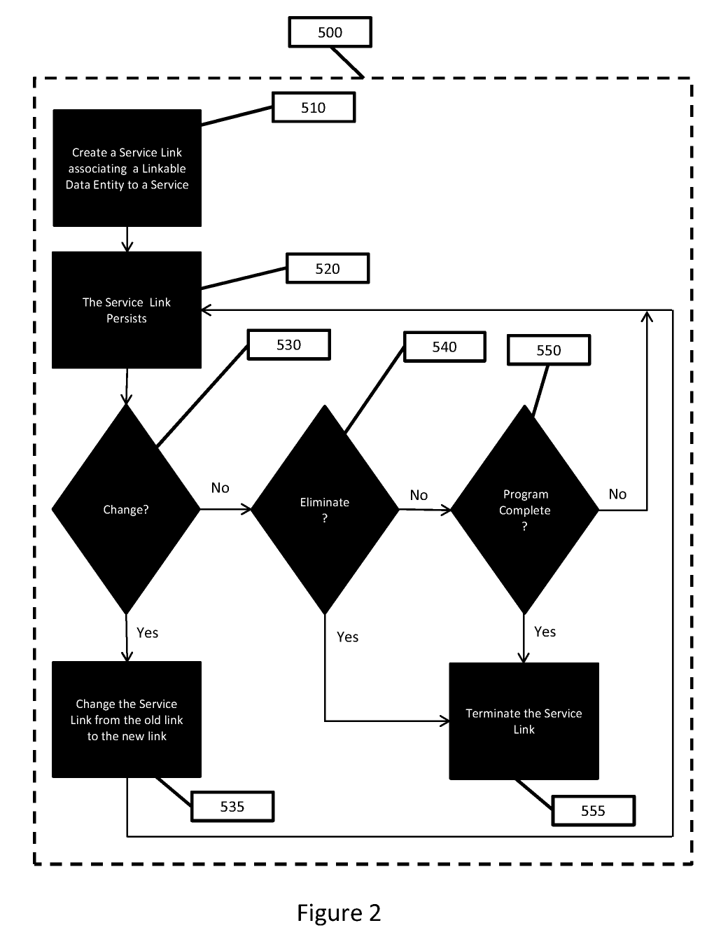

At block 150, the linkable data entity is linked or associated with the service, thereby creating a “service link.” In some embodiments, this association of the service and the linkable data entity may be accomplished using a keyword or operator. A service link may be thought of as a rule creating a loose association between a linkable data entity and a service. Once created, a service link persists until it is explicitly eliminated, changed, or until execution completes, as shown most clearly in FIG. 2.

FIG. 2 is a flow chart illustrating a method 500 demonstrating the life cycle and persistent nature of a service link. At block 510, an association between a linkable data entity and a service, or service link, is created. At block 520, the service link is shown to persist. Thereafter, the link is persistent until changed, eliminated, or until the program completes execution, as shown in decision blocks 530, 540, and 550 respectively. If, at block 530, it is determined that the service link should be changed, then at block 535, the service link is changed and the process is repeated. If, at block 540, it is determined that the service link should be eliminated, then at block 555, the service link is terminated and the process ends. When, at block 550, it is determined the end of the program is reached, the program will stop execution, terminating the service link, as shown at block 555. This persistent behavior differentiates a service link from a SOAP call to a service that may be performed using existing procedural or object-oriented programming languages. The persistent nature of a service link advantageously enables the service link to be invoked simply and efficiently, without duplication of code.

Referring again to FIG. 1, at block 160, the service link is invoked. In some embodiments, local (same host) and remote (external host) service invocations can be made using substantially similar or even identical syntax. Moreover, in some cases, the linked service can be invoked implicitly with an operator, used with an instance of the associated linkable data entity. In other cases, the linked service can be invoked explicitly using a keyword, such as “invoke.”

In computer programming, a keyword is a word or identifier that has a particular meaning to the programming language. In many languages, such as in procedural and object oriented languages, a keyword is a reserved word which identifies a syntactic form. Keywords are an integral part of the programming language itself. Also used in many programming languages are functions that are available in libraries which are a collection of subprograms used to develop software that contain “helper” code and data, which provide services to independent programs.

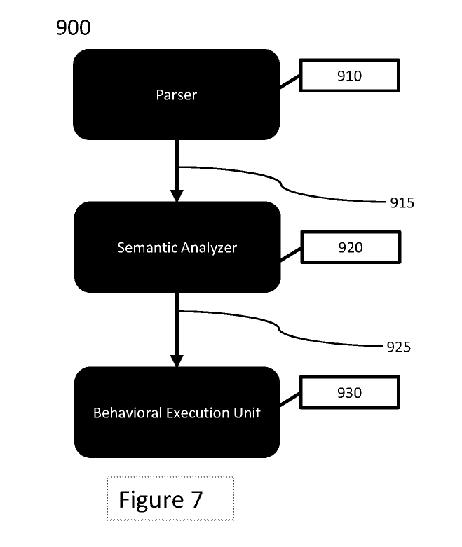

In a language processor such as a compiler or an interpreter, a keyword can be recognized and treated as a reserved word. FIG. 7 is a block diagram of one embodiment of a programming language processor 900 such as an interpreter. In the embodiment shown in FIG. 7, the language processor comprises a parser 910 that parses a program's source code. The parser 910 recognizes a programming language's keywords and operators and creates a parser output 915, such as a parse tree, reflecting the recognized keywords and operators. As shown in FIG. 7, the parser output 915 is passed to a semantic analyzer 920, which adds semantic information to the parser output 915 and generates a semantic analyzer output 925, such as a symbol table. In the embodiment illustrated in FIG. 7, the semantic analyzer output 925 is passed to a behavioral execution unit 930 that, when executed, exhibits the desired behaviors set forth in the source code.

The keywords and operators associated with service link invocation provide one example of a category of keywords and operators that are provided in the service-oriented programming language described herein, but are not available in existing procedural or object-oriented programming languages. These keywords and operators advantageously enable the service-oriented programming language to invoke services far more conveniently and efficiently than existing procedural and object-oriented programming languages. For example, services can be invoked simply using the “invoke” keyword. Alternatively, services can be invoked implicitly, without requiring an explicit “invoke” statement every time a programmer desired to invoke a link to a service, thereby reducing redundant coding. A statement that invokes the link may imply that a communication such as a SOAP call is taking place. Referring again to FIG. 1, at block 170, the method 100 ends.

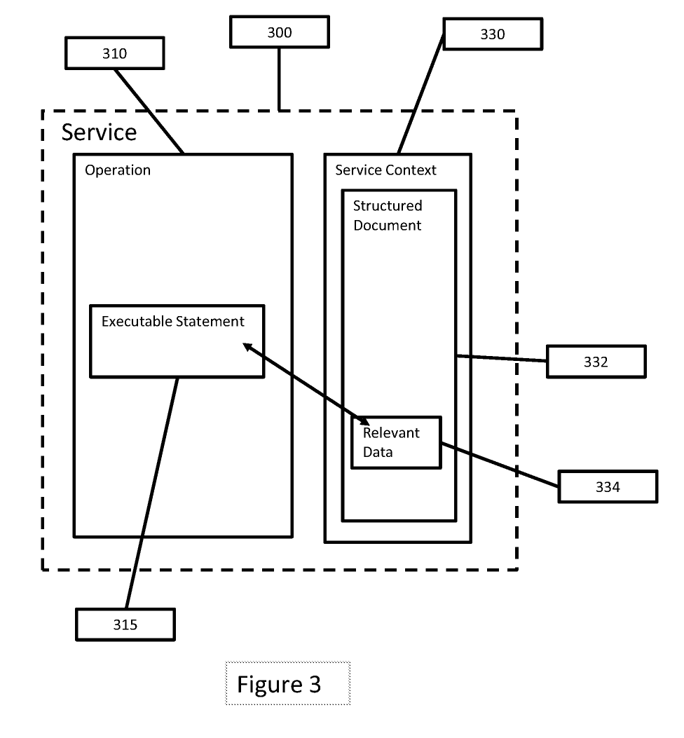

FIG. 3 is a block diagram of one embodiment of a service 300. As shown in FIG. 3, a service 300 generally comprises one or more operations 310 and a service context (“context”) 330. The operation(s) 310 may comprise one or more executable statements 315. The context 330 is the aggregate set of variable and parameter values specific to an executing service's scope. In the illustrated embodiment, the context 330 comprises a structured document 332 that may be received as an input to the service 300, as described in more detail below. The context 330 may include relevant data 334, or data that is referenced by an operation 310, as well as irrelevant data, or data that is not referenced by any operation 310 of the service 300. When executed, the service 300 can identify relevant data 334 within its context 330 using a suitable parsing tool such as XPath, and ignore any irrelevant data, if present. Accordingly, the executable statement 315 is advantageously enabled to access and reference the relevant data 334.

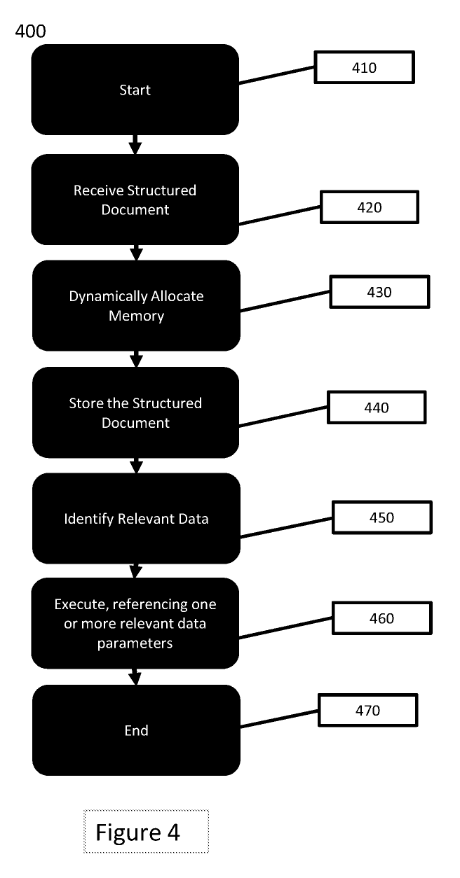

FIG. 4 is a flow chart of a service linking method 400, shown from the perspective of an external service, such as a Web service. At a first block 410, the method 400 begins. At block 420, a structured document is received by the service. This structured document includes data passed to the service from a calling program, such as an XML document passed to the service via a SOAP call. At block 430, the service allocates memory dynamically of a size to accommodate the received structured document. At block 440, the structured document is stored in the service's context, as described above in connection with FIG. 3. At block 450, the service may drill down into or parse the structured document to identify relevant data using a suitable parsing tool, such as XPath. At block 460, the service may execute one or more operations with reference to relevant data that may have been found at block 450. In many cases, the service returns the results of the operation to the calling program as part of block 460. At block 470, the execution of the service is complete and the method 400 ends.

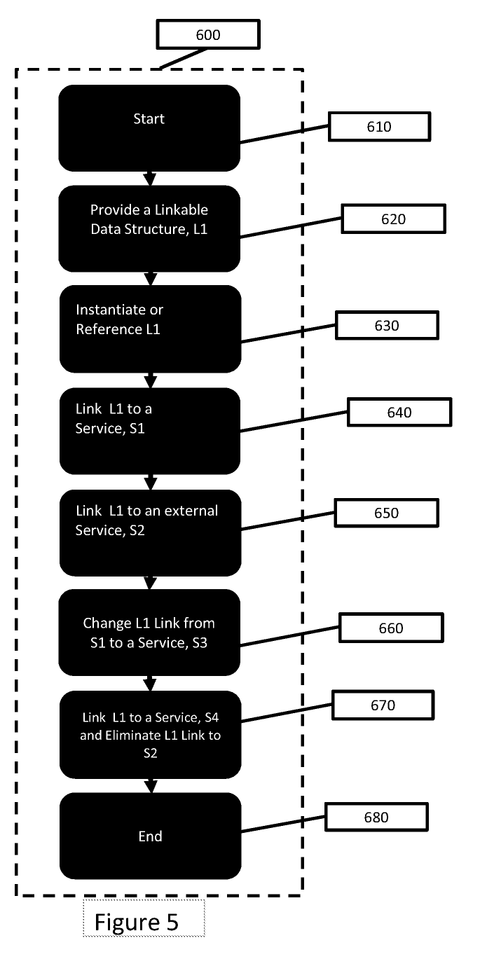

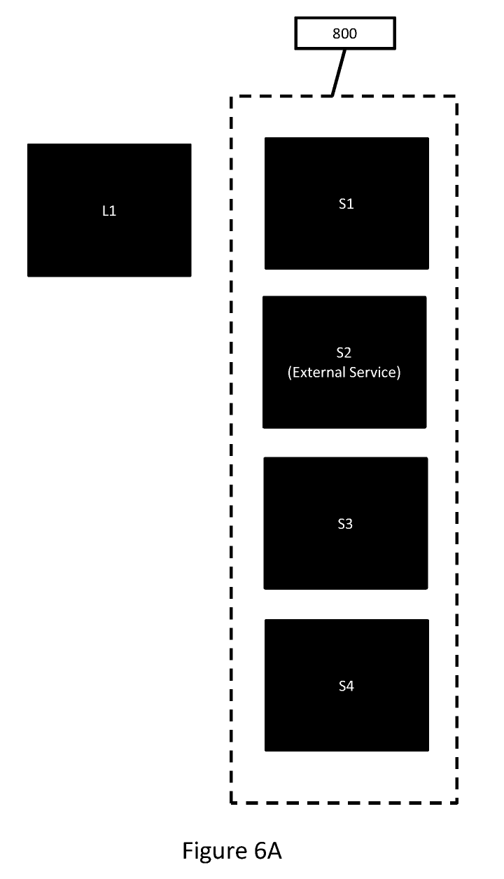

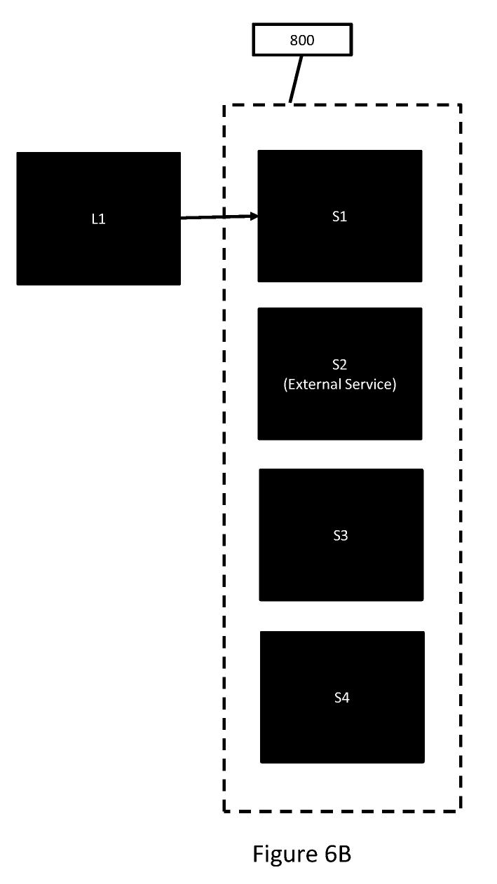

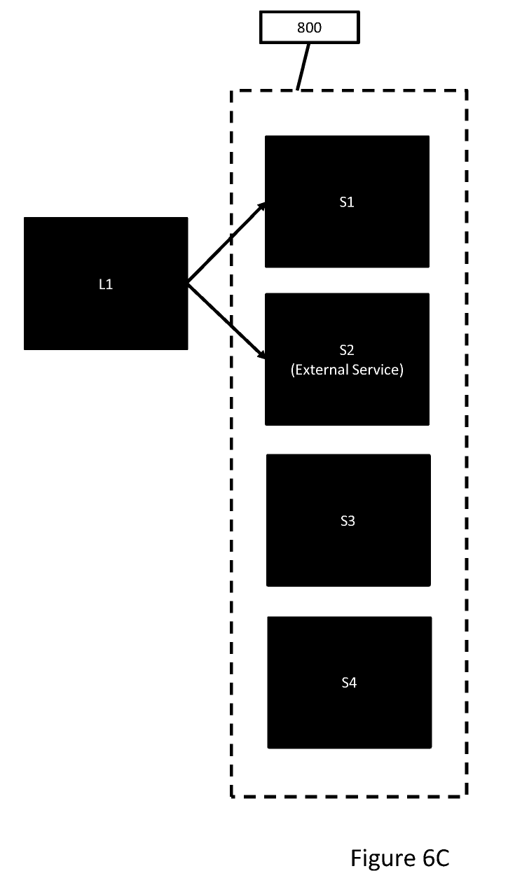

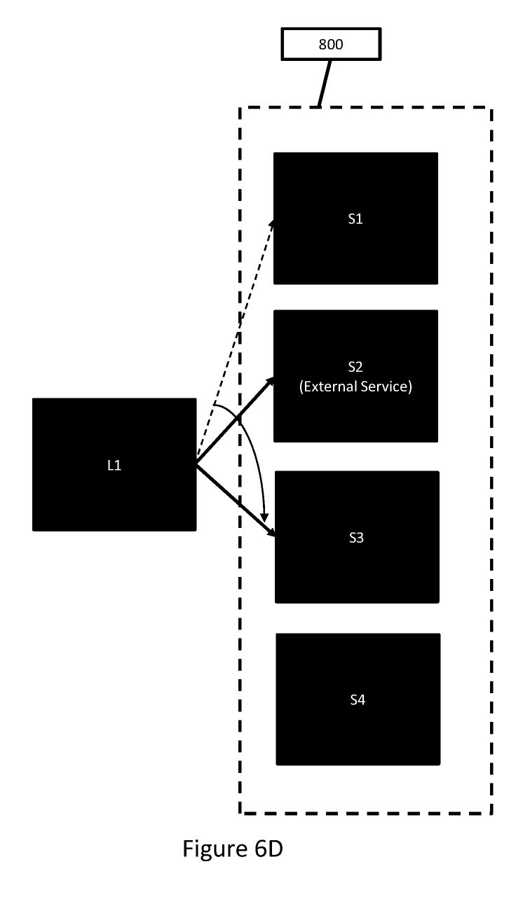

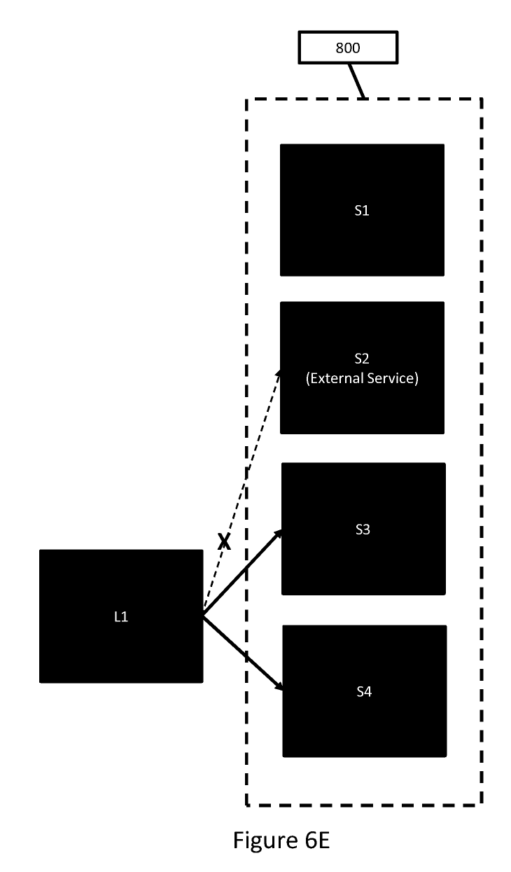

FIG. 5 is a flowchart of a method 600 demonstrating the execution of a program implementing the service linking method 100 shown in FIG. 1. FIGS. 6A-6E are block diagrams illustrating various “snapshots” of the relationship between a linkable data entity and a plurality of services at different moments in time during the execution of the program shown in FIG. 5.

Referring to FIG. 5, at a first block 610, the program starts. At block 620, a linkable data entity L1 is created, and at block 630, the linkable data entity L1 is instantiated or referenced. FIG. 6A is a block diagram providing a “snapshot” of the association between the linkable data entity L1 and a plurality of services 800, immediately following the execution of block 630. At that moment in time, as shown in FIG. 6A, the linkable data entity L1 is not associated with any services 800.

Referring again to FIG. 5, at block 640, a service link is created between the linkable data entity L1 and a first service S1. FIG. 6B is a block diagram providing a snapshot of the association between the linkable data entity L1 and the services 800, immediately following the execution of block 640. At that moment in time, as shown in FIG. 6B, the linkable data entity L1 has only one service link, associating L1 with the first service S1.

Referring again to FIG. 5, at block 650, a service link is created between the linkable data entity L1 and a second service S2. In the illustrated example, the second service S2 is an “external” service, i.e., a service external to the current executable context, such as a Web service. FIG. 6C is a block diagram providing a snapshot of the association between the linkable data entity L1 and the services 800, immediately following the execution of block 650. At that moment in time, as shown in FIG. 6C, the linkable data entity L1 has two service links, associating L1 with the first service S1 and the second service S2.

Referring again to FIG. 5, at block 660, the service link between the linkable data entity L1 and the first service S1 is changed, such that the linkable data entity L1 is associated with a third service S3 instead of the first service S1. FIG. 6D is a block diagram providing a snapshot of the association between the linkable data entity L1 and the services 800, immediately following the execution of block 660. At that moment in time, as shown in FIG. 6D, the linkable data entity L1 has only two service links, associating L1 with the second service S2 and the third service S3.

Referring again to FIG. 5, at block 670, a new service link is created between the linkable data entity L1 and a fourth service S4, and the service link between the linkable data entity L1 and the second service S2 is eliminated. FIG. 6E is a block diagram providing a snapshot of the association between the linkable data entity L1 and the services 800, immediately following the execution of block 670. At that moment in time, as shown in FIG. 6E, the linkable data entity L1 has two service links, associating L1 with the third service S3 and the fourth service S4.

Referring again to FIG. 5, at block 680, the method 600 ends. FIGS. 5 and 6 illustrate the dynamic and persistent properties of service linking. As shown in the example illustrated in FIGS. 5 and 6, service linking is dynamic, rather than being established at compile time. The services associated with a linkable data entity at any given time can change as a program executes. A type may be linked to a particular service only to have that link abolished a few lines of code later, perhaps to be replaced by a completely different link. A linked statement is not a declaration, but an assignment.

### CODING EXAMPLE 1

The following code block, referred to as Coding Example 1, illustrates one simple coding example of the service linking methods described above.

```
type vehicle
  curb-weight;
  vin;
  engine-size;
  make;
  model;
  color;
end vehicle
type car
  complexType from vehicle
    passenger-capacity;
    interior-color
  end complexType
end car
service VehicleProc
  operation GetVin
    in (phi);
    out (pho);
    pho = ctl:context/vin;
  end GetVin
end VehicleProc
link vehicle VehicleProc;
c = instance car;
c/vin = “w0f98hf04f”;
a = “Stuff”;
ls = c=>GetVin(a);
```

### CODING EXAMPLE 1

In this coding example, a type, which is a kind of linkable data entity, named vehicle (“vehicle”) is created. This type has attributes such as curb-weight and vin. Generally, a type is a data format which is not executable and is instantiated before filling with data. After the creation of vehicle, a second type named car (“car”) is created. In addition to its own attributes, car receives the attributes of vehicle through the use of derivation statement in its declaration, as shown in the line “complexType from vehicle” in the above code block. A service named VehicleProc (“VehicleProc”) is also created. This service has an operation defined within it named “GetVin”. The operation has input and output variables associated with it; “phi” and “pho.”

As described above, the type and the service may be linked using service linking. In Coding Example 1, vehicle is linked to the service “VehicleProc” using the statement “link vehicle VehicleProc;”. This statement associates the type “vehicle” to the service “VehicleProc”, creating a service link. After creation, a service link becomes an attribute of the linkable data entity. As such, the service link can be inherited by, or passed dynamically to, derived linkable data entities.

In some embodiments, linkable data entities and services possess completely independent inheritance chains. For instance, if type t1 links to service s1 this does not imply that type t2 links to service s2, even if t2 is derived from t1 and s2 is derived from s1. Current programming languages group data types and functional definitions into a single entity (e.g., a class) and then use the aggregate for inheritance purposes. Also, service links enable many-to-many relationships. This allows more than one linkable data entity to be linked to a given service and a linkable data entity to be linked to more than one service.

The concept of inheritance is demonstrated in Coding Example 1 when the link is invoked with the statement “ls=c=>GetVin(a);”. The statement “ls=c=>GetVin(a);” invokes the GetVin operation of the VehicleProc service. It is invoked implicitly by “following the link” from c (which is an instance of car, which has inherited the attributes of vehicle) to the service with which vehicle is linked. In other words, when the statement “ls=c=>GetVin(a);” is executed, the system “follows the link” from c to the service “VehicleProc” in order to execute GetVin.

When the service is invoked through this link, a parameter and a copy of car c is passed to the service VehicleProc. In some cases, this information is passed in the form of a structured document, such as an XML document, which the service VehicleProc receives as an input to its context. Thus, GetVin may access all of the members of car c. In this particular coding example, the member “vin” is accessed by GetVin in the context, as best seen in the statement “pho=ctl:context/vin”, by drilling down to the expected member. A service may use one of a number of tools, such as XPath, to drill down into a structured document.

As discussed above, the service VehicleProc can differentiate between relevant data and irrelevant data within its context, including data passed into its context via service linking. Accordingly, the service can advantageously ignore any irrelevant data passed from a program invoking a service link. For instance, in Coding Example 1, the parameter a, defined in the statement “a =“Stuff”;”, is passed into the context of the service VehicleProc when the service link is invoked, as shown in the statement “ls=c=>GetVin(a);”. Because the passed parameter, a, is irrelevant to the execution of the GetVin operation, this parameter is ignored when the VehicleProc service is executed.

This feature provides a stark contrast from existing procedural and object-oriented programming languages. Generally, for an external service to be used by a program currently, a number of parameters must be known. From the program's point of view, the data type that the service expects to receive must be known and the sent data type must be matched to what the service expects in order to use the service without an error. The return type must also be known in order to make use of returned values without an error. From the service's point of view, the service is set to receive and use predefined data types and it must receive only these data types. An error will result if too many, too few, or unexpected data types are received. Any returned value from the service to the program must also be a predefined data type.

By contrast, when the service-oriented programming language and techniques described herein are employed, a programmer can advantageously invoke a service link and pass data to a service, including irrelevant data, without fear of generating an error at run time, even if the programmer lacks intimate knowledge of the parameters expected by the receiving service. Accordingly, this feature provides distinct advantages over existing procedural and object-oriented programming languages.

As another related advantage, the compatibility of a given service with a linkable data entity depends only on the behavior of the service. For example, if the only thing a service does with its context is access the member “Id” then it may be usefully linked to any linkable data entity that possesses that member. The service does not expect data of a certain type to be sent; it only expects that the data will be in a predefined format (i.e., a structured document). The service can then parse through the sent data using a suitable parsing tool, such as XPath, searching for members that fit the form of the type of data with which the service works.

### CODING EXAMPLE 2

The following code block, referred to as Coding Example 2, illustrates another coding example of the service linking methods described above. In this example, the linkable data entity is an executable structured entity, or executable element, rather than a data format, such as a type.

```
element family
  elementi father “Jim”
      attribute name=“Jimmy”;
  end father
  elementi mother “Jill”
    elementi step-children “from previous marriage”
      elementi kid attribute fname=“Ellen”; end kid
      elementi kid attribute fname=“Bob”; end kid
    end step-children
  end mother
  elementi children “the kids”
    elementi kid attribute fname=“Bob”; end kid
    elementi kid attribute fname=“Junior”; end kid
    elementi kid attribute fname=“Missy”; end kid
  end children
end family
f = family( );
service FamilyProc
  operation GetNthKid
    in (n);
    out (matching-kid);
    matching-kid = ctl:context//kid{n};
  end GetNthKid
end FamilyProc
link family FamilyProc;
b = 2;
a = f=>GetNthKid(b);
```

### CODING EXAMPLE 2

As shown above, the executable element consists of a named block of code (“family”) which may be passed arguments and executed. Many of the statements in family begin with the keyword “elementi.” When executed, the elementi statement generates an element instance which may have attributes that hold data. In order to repeatedly reference the instance, the element is referenced with the letter “f” using the statement “f=family” shown at the end of the code block.

In all other respects, the execution of Coding Example 2 is very similar to that of Coding Example 1. Therefore, a detailed explanation of Coding Example 2 is not provided here. Rather, the reader can reference the explanation of Coding Example 1 for guidance, if desired.

Although this invention has been described in terms of certain preferred embodiments, other embodiments that are apparent to those of ordinary skill in the art, including embodiments that do not provide all of the features and advantages set forth herein, are also within the scope of this invention. Therefore, the scope of the present invention is defined only by reference to the appended claims and equivalents thereof.

What is claimed is:

1. A method of processing an executable computer program with a language processor, the method comprising:
parsing a keyword in the executable computer program, the keyword defining a SOAP service invocation;
generating a first output recognizing the presence of the SOAP service invocation in the executable computer program;
adding semantic information to the first output; and
generating a second output based on the contents of the first output and including one or more structures containing the SOAP service invocation, including a reference to an operation associated with the SOAP service.

2. The method of claim 1, further comprising:
generating a SOAP request compliant with the requirements of the referenced operation of the SOAP service; and
dispatching the SOAP request to invoke the referenced operation in the SOAP service.

3. The method claim 1, wherein the first output further recognizes an input comprising an expression evaluating to a SOAP message in its entirety or a set of expressions, each one evaluating to a value that can be packaged in a SOAP request

4. The method of claim 1, wherein the keyword is “invoke.”

5. The method of claim 1, wherein the first output comprises a parse tree.

6. The method of claim 1, wherein the second output comprises a symbol table.

7. The method of claim 1, wherein the language processor comprises an interpreter.

8. The method of claim 1, wherein the language processor comprises a compiler.

9. A method of processing an executable computer program with a language processor, the method comprising:
parsing a keyword in the executable computer program, the keyword defining a SOAP service,
generating a first output recognizing the presence of the SOAP service in the executable computer program, as well as one or more operations and message input and output types associated with the SOAP service;
adding semantic information to the first output; and
generating a second output based on the contents of the first output and including one or more structures containing the SOAP service, including one or more associated operations, message input and output type references, and statements defining behaviors of each operation.

10. The method of claim 9, further comprising, upon invocation of the SOAP service, exhibiting behaviors defined within the SOAP service.

11. The method of claim 9, wherein the keyword is “service.”

12. The method of claim 9, wherein the first output comprises a parse tree.

13. The method of claim 9, wherein the second output comprises a symbol table.

14. The method of claim 9, wherein the language processor comprises an interpreter.

15. The method of claim 9, wherein the language processor comprises a compiler.

16. A method for linking one or more SOAP services to a linkable data entity in an executable computer program, the method comprising:
identifying the linkable data entity;
associating the linkable data entity with one or more SOAP services,
wherein the SOAP services associated with the linkable data entity at any given time can change as the computer program executes, and
wherein, once a SOAP service is associated with the linkable data entity, the association persists until it is eliminated, changed, or the computer program completes execution.

17. The method of claim 16, wherein the linkable data entity is implemented in a service-oriented programming language.

18. The method of claim 16, wherein the SOAP service is implemented in a service-oriented programming language.

19. The method of claim 16, wherein associating the linkable data entity with one or more SOAP services comprises utilizing a keyword in a service-oriented programming language.

20. The method of claim 16, wherein associating the linkable data entity with one or more SOAP services comprises utilizing an operator in a service-oriented programming language.
